(19) United States
(12) Patent Application Publication
(10) Pub. No.: US 2024/0263326 A1
(43) Pub. Date: Aug. 8, 2024

(54) A METHOD FOR PRODUCING ELECTRODES FOR ELECTROLYSIS

(71) Applicant: HYDROGENPRO ASA, Porsgrunn (NO)

(72) Inventors: Lars Pleth NIELSEN, Porsgrunn (NO); Richard ESPESETH, Porsgrunn (NO); Per MØLLER, Porsgrunn (NO); Marcus Viktor KRAGH-SCHWARZ, Porsgrunn (NO); Morten Linding FREDERIKSEN, Porsgrunn (NO)

(21) Appl. No.: 18/561,810

(22) PCT Filed: May 19, 2022
(86) PCT No.: PCT/EP2022/063586

§ 371 Date: Nov. 17, 2023

(30) Foreign Application Priority Data
May 19, 2021 (EP) 21174639.1

(51) Int. Cl. C25B 11/052; C25B 1/04; C25B 11/031; C25B 11/061; C25B 11/075; C25D 5/40; C25D 5/48; C25D 5/50

(52) U.S. Cl. CPC C25B 11/052; C25B 11/031; C25B 11/061; C25B 11/075; C25D 5/40; C25D 5/48; C25D 5/50; C25B 1/04

(57) ABSTRACT

The present invention relates to a method for producing an electrode for alkaline electrolysis based on a composition of metal sulfides on a Ni foam substrate. The metal can be Mo, Ni, Co, Fe and/or W. In a first step S1), there is performed a metal deposition, e.g. by electroplating, the metal, Me1/Me2, being Mo, Ni, Co, Fe, and/or W, on a Ni foam substrate resulting in a metal-Ni compound being formed on and/or in the Ni foam substrate. In a second step, S2) there is performed a sulfiding on the metal-Ni compound from the first step S1). The third step S3) is an optional repetition of S1 and/or S2 at least one time. The step S1) and step S2) thereby result in the formation of electrocatalytic active nano-sites with Me1-Me2-S—Ni compounds. It is found that these nano-sites are capable of reducing the so-called overpotential of the electrodes during alkaline water electrolysis, and the production of electrodes may be significantly simplified.

### TECHNICAL FIELD OF THE INVENTION

The present invention relates to a method for producing an electrode, such as an anode and/or a cathode, to be used in alkaline water electrolysis, the electrode for alkaline electrolysis is preferably based on a composition of metal sulfides on a Ni foam substrate, the metal being Mo, Ni, Co, Fe and/or W. In particular, the present invention further relates to a corresponding electrode for alkaline water electrolysis and a corresponding electrolysis system for alkaline water electrolysis.

### BACKGROUND OF THE INVENTION

Hydrogen is a very interesting and important part of the energy system—especially in the upcoming Power-to-X (PtX) strategies. By converting green electricity from wind turbines, photovoltaic cells and water-based power plants into hydrogen, the energy can either be used directly in the transport sector, stored for later use, or converted together with carbon dioxide (CO₂) into so-called green methane, green methanol, green diesel or green aviation fuel. Hereto comes that it is relatively cheaper to transport energy as hydrogen through piping systems as compared to transporting energy as electricity through copper wires over the electric grid.

Water electrolysis can be broadly classified into three different technologies: Solid Oxide Electrolysis (SOE), Proton Exchange Membrane (PEM) Electrolysis and Alkaline Water Electrolysis (AWE). Furthermore, on a more academic level, water can also be split into H₂ and O₂ by thermolysis, photolysis and microbial electrolysis although these technologies are much less matured.

Hydrogen production by alkaline water electrolysis (AWE) is a well-established technology up to the megawatt level. H₂ is produced at the cathode surface forming hydroxyl ions (OH−), which migrate through a porous diaphragm membrane to the anode under the influence of the electrical field between the anode and cathode. Subsequently, two hydroxyl ions (OH−) are discharged forming oxygen (O₂) and water (H₂O). Oxygen atoms combines at the surface of the anode and escapes as oxygen (O₂).

The underlying reactions are:

$$\\ \begin{matrix}Anode reaction : 2 OH ‐ \to {H}_{2} O + 1 / 2 {O}_{2} + 2 e ‐ & ( 1 )\end{matrix}$$

$$\\ \begin{matrix}Cathode reaction : 2 {H}_{2} O + 2 e ‐ \to {H}_{2} + 2 OH ‐ & ( 2 )\end{matrix}$$

$$\\ \begin{matrix}Overall cell reaction : {H}_{2} O \to {H}_{2} + 1 / 2 {O}_{2} & ( 3 )\end{matrix}$$

The anode/cathode for alkaline water electrolysis is typically a nickel-based material. Nickel is stable in the concentrated KOH solution. Lifespans beyond 25 years and decades of stability of Ni-based electrodes in alkaline water electrolysis have been reported. Conventionally, porous nickel, such as e.g. a nickel foam or different Ni alloys, has been used as standard electrode material to increase the surface area.

There is continuously ongoing research and development activities focusing on improved electrodes for alkaline electrolysis by lowering the overpotential for hydrogen and oxygen formation.

One recent example is US patent application US2019106797 (Siemens), wherein an electrolytic cell for alkaline water electrolysis with in-situ anode activation is disclosed. The electrolytic cell comprises: an anode; a cathode wherein at least a part of a surface of the cathode comprises an electrically conducting stable material, such as nickel, and an anode catalytic material, such as cobalt, manganese, etc., adapted to be released from the surface of the cathode in alkaline water and be deposited at the surface of the anode when an electric voltage is applied across the anode and the cathode; and a diaphragm separating the anode and the cathode, wherein the diaphragm is gas tight and is permeable to the anode catalytic material. However, the use of a diaphragm separating the anode and the cathode being permeable to the anode catalytic material may not be advantageous in some electrolytic cells, and the manufacturing method of the electrodes is relatively complex.

Chinese patent application CN 106 917 105 provides a preparation method for a transition metal sulfide electrode for water decomposition, and belongs to the field of electric catalysis water decomposition. The electrode is obtained by modifying the surface of foamed nickel by an electric deposition method to synthesize a binary or multi-element alloy. A synthesized foamed transition metal is immersed in a thiourea solution for hydrothermal reaction to obtain the double-function transition metal sulfide foamed electrode. The prepared sulfide electrode is synchronously applied to a cathode and an anode, and achieves advantageous electro-catalysis hydrogen evolution and oxygen evolution. However, this treatment in liquid thiourea is relatively long and complicated from a process point of view, and the resulting electrode is most likely brittle and will have a reduced bulk conductivity.

Hence, an improved method for manufacturing or producing an electrode for alkaline water electrolysis would be advantageous, and in particular a more efficient and/or reliable method for producing an electrode would be advantageous.

### SUMMARY OF THE INVENTION

Thus, an object of the present invention relates to an improved method for producing an electrode for alkaline water electrolysis.

In particular, it is an object of the present invention to provide an improved method for producing or manufacturing an electrode for alkaline water electrolysis that solves the above-mentioned problems of the prior art with complex manufacturing methods for electrodes for use in alkaline water electrolysis.

Thus, the first aspect of the invention relates to a method for producing an electrode for alkaline electrolysis based on a composition of metal sulfides on a Ni foam substrate, the metal being Mo, Ni, Co, Fe and/or W, the method comprising initially providing a nickel (Ni) foam substrate, the method comprising the separate steps of:
S1) performing a metal deposition, preferably by electroplating, the metal being Mo, Ni, Co, Fe, and/or W, on said Ni foam substrate resulting in a metal-Ni compound being formed on and/or in the Ni foam substrate, and
S2) performing a sulfiding on said metal-Ni compound, and
S3) optionally repeating, at least one time, said step S1) and/or said step S2) thereby resulting in the formation of electrocatalytic active nano-sites comprising Me1-Me2-S—Ni compounds capable of reducing the overpotential of the electrode during alkaline water electrolysis, wherein Me1 is a metal chosen from the group consisting of Mo, Ni, Co, Fe, and/or W, and wherein Me2 is a metal chosen from the group consisting of Mo, Ni, Co, Fe, and/or W.

Advantageous, the present invention provides a relative simple and efficient method for producing electrodes, which has the potential to significantly reduce complexity, both with respect to time and cost, in producing electrodes for alkaline electrolysis.

A second aspect of the present invention relates to a method for producing an electrode for alkaline electrolysis based on a Ni foam substrate, the method comprising initially providing a nickel (Ni) foam substrate, the method comprising the separate step of:
S2) performing a sulfiding said Ni foam substrate, and
S3) optionally repeating, at least one time, said step S2), thereby resulting in the formation of electrocatalytic active nano-sites comprising Ni—S compounds capable of reducing the overpotential of the electrode during alkaline water electrolysis.

Yet another aspect of the present invention is to provide an electrode for alkaline water electrolysis according to the first or the second aspect. Yet another aspect of the present invention is to provide an electrolysis system with electrodes according to the first, the second and/or any other aspects for alkaline water electrolysis or other electrochemical applications as mentioned below.

In yet another aspect, the present invention relates to a method for producing an electrode for alkaline electrolysis based on a composition of metal selenides, or metal tellurides, on a Ni foam substrate, the metal being Mo, Ni, Co, Fe and/or W, the method comprising initially providing a nickel (Ni) foam substrate, the method comprising the separate steps of:
S1′) performing a metal deposition, preferably by electroplating, the metal being Mo, Ni, Co, Fe, and/or W, on said Ni foam substrate resulting in a metal-Ni compound being formed on and/or in the Ni foam substrate, and
S2′) performing a reaction with a selenide reactant, or telluride reactant, on said metal-Ni compound, and
S3′) optionally repeating, at least one time, said step S1′) and/or said step S2′)
thereby resulting in the formation of electrocatalytic active nano-sites comprising Me1-Me2-Se—Ni compounds, or Me1-Me2-Te—Ni compounds, capable of reducing the overpotential of the electrode during alkaline water electrolysis, wherein Me1 is a metal chosen from the group consisting of Mo, Ni, Co, Fe, and/or W, and wherein Me2 is a metal chosen from the group consisting of Mo, Ni, Co, Fe, and/or W.

A primary application of the present invention according to any of the above-mentioned aspects relates to improved alkaline electrolysis by providing electrocatalytic active nano-sites. However, it is contemplated and suggested by theoretical considerations that the electrodes and the corresponding method for producing such electrodes may also be beneficially applied in connection with electrodes for Cl₂ production, electrocatalytic production of NH₃ or CO₂ conversion to CO.

### BRIEF DESCRIPTION OF THE FIGURES

FIG. 1 shows an example of reduced overvoltage for hydrogen formation as compared to an untreated Ni reference at pilot scale level 10 m³/h at 30 bar,

FIG. 2 shows a Pourbaix diagram for NiTe₂ in the entire pH range from 0 to 14,

FIG. 3 shows a flow chart of the present invention for a method for producing an electrode for alkaline electrolysis,

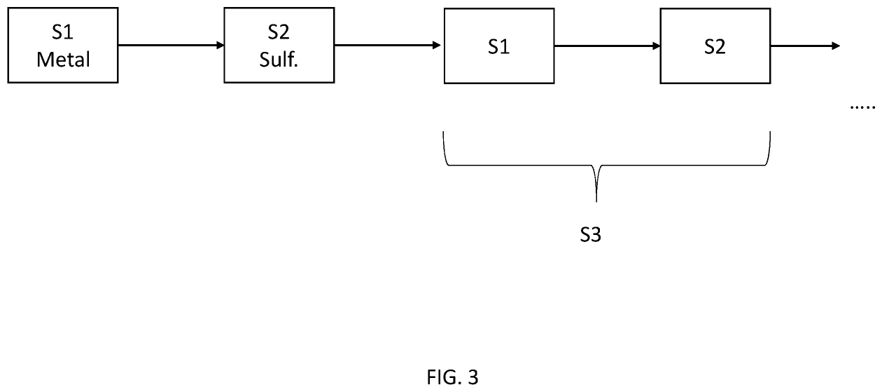

FIG. 4 shows another flow chart of the present invention for a method for producing an electrode for alkaline electrolysis having preliminary treatment with heating and post-treatment with heating,

FIG. 5 shows a principle drawing of electrolytic deposition of metal in an electrolytic cell where the metal layer is deposited on the cathode,

FIG. 6 shows a principle drawing of an oven heating a nickel foam in a H₂S containing gas to perform sulfiding of the substrate,

FIG. 7 shows three different levels of an electrolysis system according to the present invention; in A) a photograph of an electrolysis configuration is shown based on Ni foam electrodes, where in the enlargement B) the Ni foam on both the anode and the cathode side is schematically illustrated, and the additional enlargement C) shows a schematic illustration of these electrocatalytic active nano-sites on a part of the Ni foam according to the present invention,

FIG. 8 shows the effect of sulfiding a Ni foam in 3% H₂S at 75 deg. C., where the two left SEM images (high and low magnification) shows the pure Ni surface before sulfiding, whereas the middle and right set of SEM images shows the effect of 1 hours and 2 hours sulfiding, respectively, and

FIG. 9 shows three polarisation curves for the necessary voltage for hydrogen/oxygen formation as a function of the applied current density in 30% KOH at 90 deg. C. for various treatment of Ni foam.

The present invention will now be described in more detail in the following.

### DETAILED DESCRIPTION OF THE INVENTION

Prior to discussing the present invention in further details, the following terms and conventions will first be defined:

In context of the present application, it may be understood that the term ‘electrodes’ is to be interpreted broadly as the skilled person in electrochemistry will readily understand. Thus, electrodes according to the present invention may form part of one, or more, electrolytic cell(s), for example a single electrolytic cell, stacked electrolytic cells, low pressure electrolytic cells, high pressure electrolytic cell, a traditional electrolytic cell, a zero gap electrolytic cell, an electrolytic cell with gas diffusion layers in between, etc.

In context of the present application, it may be understood that the term ‘metal’ is to be interpreted broadly as the skilled person will readily understand, in particular that a metal may comprise impurities to a certain extent under realistic working conditions in production facilities for electrodes, and in particular that some metals may have a certain degree of metal oxide formation, on the surface and/or in the bulk, e.g. iron oxide formation like Fe₂O₃, etc.

In context of the present application, it may be understood that the term metal compounds of the type Me1-Me2-S—Ni is to be interpreted broadly as the skilled person will readily understand, in particular that various stoichiometry relations between the Me1 and Me2 and sulfur are possible on the Ni foam substrate. Thus, Me1-Me2-S—Ni is to be interpreted as Me1_{A}-Me2_{B}-S_{C}—Ni, where stoichiometric coefficients A, B and C may vary over a range over meta-stable and/or thermodynamically stabile compounds depending on the specific metals of Me1 and/or Me2 used in the electrodes and being highly dependent on the degree of sulfiding, sulfiding partial pressure as well as the temperature during sulfiding, as the skilled person will readily understand from the below explanations and examples. It is also contemplated that Me1 and/or Me2, both being a metal chosen from the group consisting of Mo, Ni, Co, Fe, and/or W, may—to some extent—form various metal oxides in the Me1-Me2-S—Ni compounds according to the present invention. Thus, if Me1 is iron, a certain amount of the iron may form Fe₂O₃-oxides (Fe₂O₃, Fe₃O₄, Fe(OH)₂ and, Fe(OH)₃) in the electrodes. Similar oxidation or partial oxidation may be seen for other involved metals.

In context of the present application, it may be understood that the term ‘sulfiding’ is generally to be interpreted broadly and refer to any chemical reaction with sulfur to form sulfides, also know as a sulfidation. In US English, the corresponding spelling is sulphiding to form sulphides, etc.

Since the sulfiding step may be based on a sulfur diffusion, e.g. via H₂S gas, and subsequent reaction, it will be possible to document a diffusion-based production process by analysing the sulfur depth profile. If the sulfiding process is based on diffusion, there will be a decreasing sulfur concentration upon going deeper into the electrode incl. the Ni foam implying deeper into the structure of the Ni foam or deeper into a deposited metal overlayer. In advantageous embodiments, only on the surface part of the Ni substrate there is performed a sulfidation, which has the advantage of maintaining, at least to a substantial extent, the bulk properties of the Ni substrate, such as strong/flexible mechanical properties and relatively high conductivity. Thus, in the context of the present application, it is to be understood that a surface constitutes an upper boundary volume or region of the Ni substrate, such as a surface having a depth of about 200, 300, 400, 500 or 1000 nm. Therefore, the concept of performing a sulfiding only of the surface will be readily understood by a skilled person in this technical field.

Alternatively, sulfur may be added through co-deposition and there will be a relatively more abrupt change in the sulfur concentration profile as a function depth into the electrode coating. A co-deposition will not go into the substrate except if it involves a subsequent heating process where again the S-profile will be more abruptly going down to zero as compare to a diffusional sulfiding process.

Suitable analysis techniques for probing the sulfur depth profile is Rutherford Backscattering Spectrometry (RBS), Focused Ion Beam Scanning Electron Microscope (FIB-SEM) equipped with Energy-dispersive X-ray spectroscopy (EDX/EDS), Glow Discharge Optical Emission Spectroscopy (GDOES) or similar depth resolved elemental analysis techniques as the skilled person will readily understand.

In context of the present application, it may be understood that the term ‘nano-sites’ is to be interpreted broadly as the skilled person in surface physics and/or surface chemistry will understand. Thus, the Me1-Me2-S—Ni compounds may form electrocatalytic nano-sites having a characteristic dimension, such as (average) diameter or length scale, of 1-1000 nm, preferably 10-500 nm, more preferably, 20-200 nm. Clearly, if electroplating thicker layers (in step1 S1) the active layer may be even thicker after sulfiding in step S2.

### EMBODIMENTS

In one advantageous embodiment, the method for producing an electrode according to the first aspect may comprise that step S1) and step S2) are performed as separate and distinct steps in a production line for producing or manufacturing the electrode. In this particular embodiment, in the method for producing an electrode according to the first aspect, the Me1 metal may be different from the Me2 metal, and the metal deposition results in the metal Me1 being deposited, and second and sequent metal deposition results in the metal Me2 being deposited. Thus, beneficially S1 and S2 are performed at different locations in a production line facilitating a significant simplification of the production process.

In embodiments, where the metals Me1 and Me2 may be one and the same metal, the resulting Me1-S—Ni compound is also part of the present invention, and it may be the result of a single metal deposition by step S1), or repeated step of metal deposition; S1), S1), S1), etc., either at the same place in a production line, or at several positions in a production line depositing the same kind of metal, either by an identical metal deposition technique or by different metal deposition techniques. Alternatively, though it may also not form part of the present invention that the first Me1 and second Me2 are one and the same metal.

In another embodiment, where the method for producing an electrode is according to the first aspect, the Me1 metal may be different from the Me2 metal, and where said Me1 metal and said Me2 metal are being deposited in the same step S1) of metal deposition. Thus, for example combination of some metal compounds like CoMo may be performed at the same time, e.g. by electroplating at the same time.

According to literature, there are potential improvements by different steps in the catalyst formulation. The impregnation of Ni prior to Co results in higher dispersion of molybdenum. The tri-metallic catalyst Co—NiMo/γ-Al₂O₃ synthesized has been observed to have a higher hydrodesulfurization (HDS) and hydrodenitrogenation (HDN) activity as compared to that shown by bimetallic catalysts. The higher activity shown by tri-metallic CoNiMo catalysts may be ascribed to the double promotional effect of Co and Ni and formation of three types of active phases NiMOS, CoMOS and Ni—CoMOS, cf. Effect of synthesis technique on the activity of CoNiMo tri-metallic catalyst for hydrotreating of heavy gas oil, Catalysis Today, Volume 291, 1 Aug. 2017, Pages 160-171.

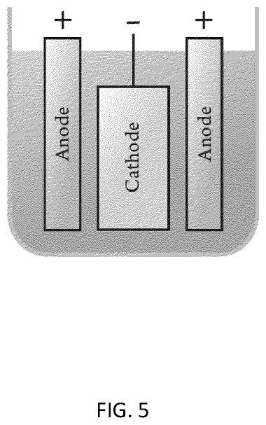

In another embodiment, the method for producing an electrode according to the first aspect relates to a metal deposition, where step S1) is performed by electroplating, preferably DC electroplating, pulse electroplating or ionic electroplating, or any combinations thereof. Other alternatives contemplated: PVD (DC sputtering, RF sputtering, HiPIMS, pulse DC, etc.), CVD processes, various types of thermal spraying, electroplating (DC, pulse plating or ionic plating). Liquid infiltration followed by calcination, etc., as will readily be understood by the skilled person once the teaching and principle of the present invention is fully comprehended. In FIG. 5, a conventional electroplating is schematically indicated. The metal source for the coating is supplied by the two anodes (+) as well as by the metal ions in the bath. The energy is supplied by an external power supply (not shown). The metal layer is then deposited at the cathode (−).

In another embodiment, the method for producing an electrode according to the first aspect, a step S2) of sulfiding on said metal-Ni compound may be performed with a sulfiding medium comprising hydrogen sulfide, H₂S, alternatively dimethyl sulfide (DMS), dimethyl sulfoxide (DMSO, (CH₃)2SO), Ethyl Mercaptan (CH₃CH₂SH), Butyl Mercaptan (C₄H₁₀S), thiourea, C₂S₂ or H₂S₂. It is also contemplated that heating in packed bed with S-containing granulates or elemental sulfur may be beneficially applied in the present invention.

In advantageous embodiments, the method for producing an electrode according to the first aspect may relate to the Ni foam being replaced by a foam from any of the metals chosen from the group consisting of Fe, Co, Cr, and Cu.

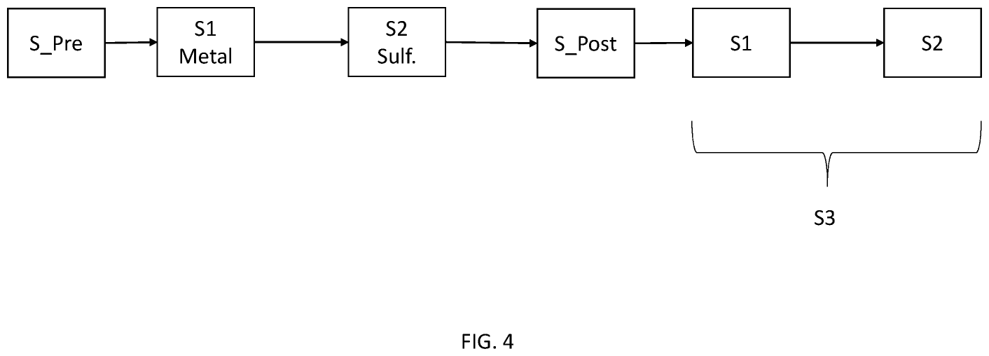

In useful embodiments, the method for producing an electrode according to the first aspect may relate to an additional heating step being performed at various positions in the overall process according to the present invention:
S_Pre) before step S1) metal deposition,
S_Inter) between S1) metal deposition and S2) sulfiding, and/or
S_Post) after S2) sulfiding, and any combinations thereof.
   as will be explained in more detail below, cf. FIG. 4.

In advantageous embodiments, the method for producing an electrode according to the first aspect may relate to step S1), in an initial execution, being omitted thereby resulting in step S2 being a pre-sulfiding step of the Ni foam substrate.

In advantageous embodiments, the electrocatalytic active nano-sites may comprise Me1-Me2-S—Ni compounds capable of reducing the overpotential of the electrode during alkaline water electrolysis comprises primarily edge sites situated on the edge of the said nano-sites. Thus, the Haldor Topsøe research team has together with Aarhus university and DTU in Denmark verified both experimentally and theoretically the existence of very active “BRIM® sites”, at the edges of the molybdenum disulfide nanocrystals. These edge sites with and without the presence of Ni/Co-edge atoms are believed to highly catalytic active sites for HDN and HDS. These sites interact with hydrogen and may also be very active in connection with alkaline electrolysis, cf. Atomic-Scale Structure of Co—Mo—S Nanoclusters in Hydrotreating Catalysts, J. V. Lauritsen, S. Helveg, E. Lægsgaard, I. Stensgaard, B. S. Clausen, H. Topsøe, F. Besenbacher, Journal of Catalysis, Volume 197, Issue 1, 1 Jan. 2001, Pages 1-5.

In other advantageous embodiments, the electrocatalytic active nano-sites may comprise Me1-Me2-S—Ni compounds capable of reducing the overpotential of the electrode during alkaline water electrolysis comprising primarily sulfur deficient sites with near metallic properties. Thus, the reactivity and the ability to lower the voltage for hydrogen formation might be related to the degree of sulfur vacancies (sulfur deficient sites).

In some advantageous embodiments, the Ni foam may be replaced by a Ni woven structure, a Ni plate, or a Ni mesh, or any combination of such substrates as the skilled person will readily understand is within the scope and general principle of the present invention.

In still other advantageous embodiments, where the step S2) of sulfiding of said Ni foam substrate may performed with a gas or a gas composition having the advantage of relatively quick and easy application to the electrodes during manufacturing. This may preferably be with a H₂S gas, optionally with a composition of 1-10 vol. % H₂S, preferably 2-4 vol. % H₂S, more preferably around 3 vol. % H₂S. It may alternatively be around 20, 30, 40, 50, 60, 70, 80, 90 or 100 vol. % of H₂S.

Advantageously, the step S2) of sulfiding of said Ni foam substrate may be performed only on a surface part of the Ni foam substrate in order to maintain to a substantially extent the beneficial bulk properties, e.g. mechanical and electrical properties, while modifying the electrocatalytic surface properties.

In advantageous embodiments of the invention according to the second aspect in a step S1), metal deposition is performed prior to the sulfiding step S2), preferably by electroplating, the metal being Mo, Ni, Co, Fe, and/or W, on said Ni foam substrate resulting in a metal-Ni compound being formed on and/or in the Ni foam substrate.

It should be noted that embodiments and features described in the context of one of the aspects of the present invention also apply to the other aspects of the invention. Thus, the skilled person in electrochemistry will readily understand that the various steps for producing a new and advantage electrode may swiftly be implemented in an electrode.

All patent and non-patent references cited in the present application are hereby incorporated by reference in their entirety.

The invention will now be described in further details in the following non-limiting examples.

### Example 1: Lowering of the Overpotential for Hydrogen Formation in Alkaline Electrolysis

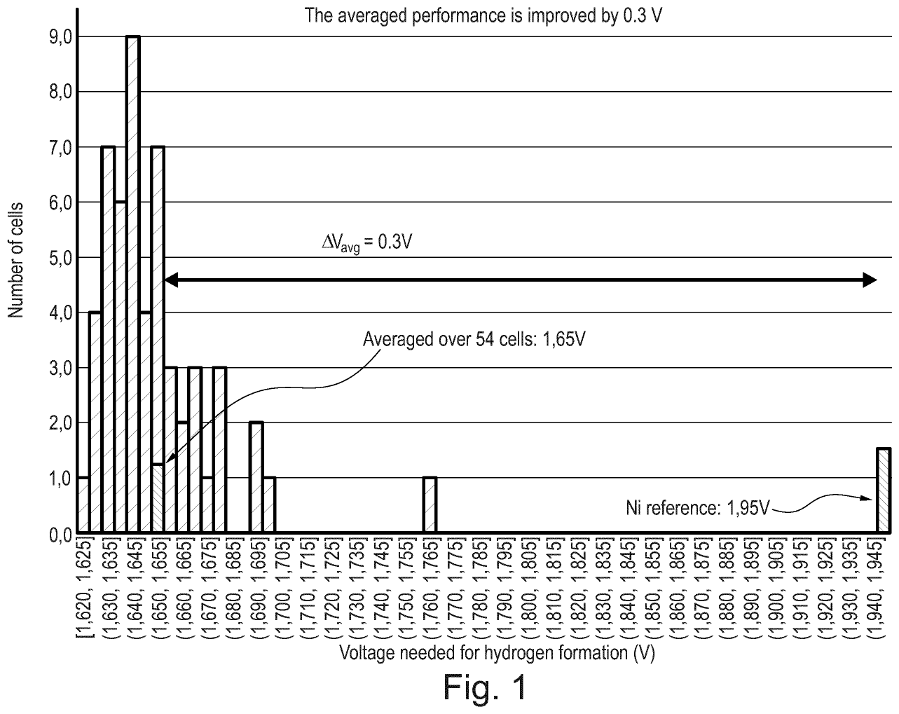

EP 0 235 860 covers a method for manufacturing an electrode for making H₂ and O₂ in an alkaline media, which comprises electro-deposition a catalytic layer which contains at least Ni and S, on an electrical-conducting substrate. Following the ideas outlined in EP 0 235 860 electroplating with suitable Ni-salts and suitable sulfur-releasing agents the present inventors fabricated and assembled 54 electrodes Ø60 in an alkaline pilot electrolysis unit. As seen in FIG. 1, the voltage for hydrogen formation was on the average lowered by 0.3V as compared to an untreated Ni reference. The best performing electrode lowered the voltage for hydrogen formation with 0.33V.

FIG. 1 shows on the left a histogram over 54 Ø60 cm electrodes showing the number of electrodes generating hydrogen in a specific voltage interval. Each interval is 0.005V. On the average, the voltage for hydrogen formation is lowered by 0.3V as compared to the red untreated nickel reference, which generates hydrogen at 1.95V. The best electrode needs only 1.62V for hydrogen formation corresponding to a decrease of 0.33V for hydrogen formation.

### Example 2: Thermodynamic Stability of Different Metal Sulfides Under Alkaline Electrolysis Conditions

Table 1 and Table 2 below shows the calculated delta G value for the following two reactions:

$$\\ \begin{matrix}{MoS}_{2} + 4 KOH = {MoO}_{2} + 2 {H}_{2} O + 2 {K}_{2} S & ( i )\end{matrix}$$

$$\\ \begin{matrix}{WS}_{2} + 4 KOH = {WO}_{2} + 2 {H}_{2} O + 2 {K}_{2} S & ( ii )\end{matrix}$$

TABLE 1
MoS₂ + 4KOH = MoO₂ + 2H₂O + 2K₂S

| T(° C.) | Delta G (kcal) |
|---|---|
| 0 | 12,539 |
| 10 | 12,473 |
| 20 | 12,405 |
| 30 | 12,335 |
| 40 | 12,265 |
| 50 | 12,194 |
| 60 | 12,121 |
| 70 | 12,048 |
| 80 | 11,974 |
| 90 | 11,899 |
| 100 | 11,824 |

The predicted stability of MoS₂ under KOH conditions. As evident from the calculated positive Delta G value, it is not possible to decompose MoS₂ in a KOH solution below 100° C.

TABLE 2
WS₂ + 4KOH = WO₂ + 2H₂O + 2K₂S

| T(° C.) | Delta G (kcal) |
|---|---|
| 0 | 8,266 |
| 10 | 8,195 |
| 20 | 8,123 |
| 30 | 8,049 |
| 40 | 7,975 |
| 50 | 7,899 |
| 60 | 7,823 |
| 70 | 7,745 |
| 80 | 7,667 |
| 90 | 7,588 |
| 100 | 7,508 |

The predicted stability of WS₂ under KOH conditions. As evident from the calculated positive Delta G value, it is not possible to decompose WS₂ in a KOH solution below 100° C.

From the calculated positive delta G values, it can be concluded that it is not thermodynamically possible below 100° C. to transform MoS₂ or WS₂ to the corresponding oxides (MoO₂ or WO2) in the presence of KOH. Hence, it can be concluded that MoS₂ and WS₂ are thermodynamically stable under typical conditions used in alkaline electrolysis (20-30% KOH and 90° C.).

### Example 3: Calculated Stability of Metal Tellurides

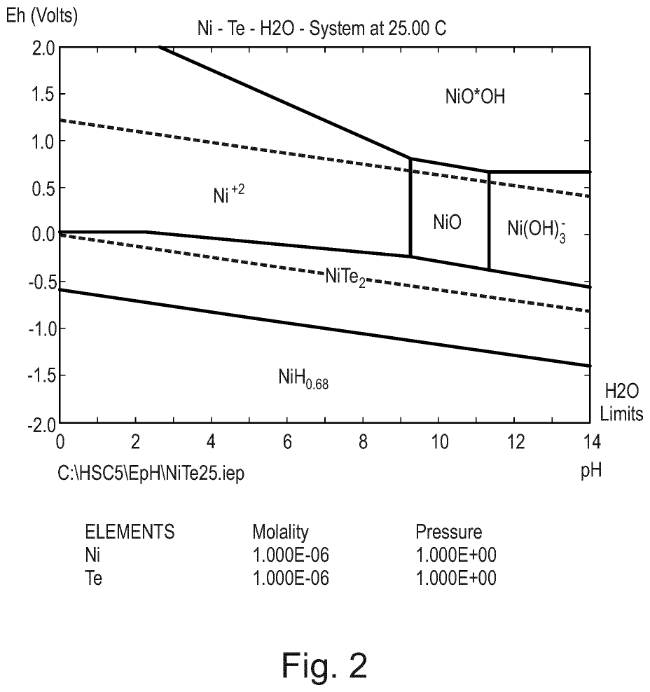

FIG. 2 shows a Pourbaix diagram indicating that NiTe₂ is stable under the hydrogen formation line in the entire pH range from 0 to 14 which makes it very suitable as electrode material on the cathode side.

As can be seen from the Pourbaix diagram in FIG. 2, NiTe₂ is stable in the entire pH-range, below the stability area of water where water is forming hydrogen (the lower dashed line). This implies that NiTe₂ is stable in the environment relevant for alkaline electrolysis as a hydrogen-forming cathode. Thus, in one aspect of the invention sulfur may be replaced with tellur.

### Example 4: Stable Co—Mo—S—, Ni—Mo—S—, Co—Ni—Mo—S, Co—W—S—, Ni—W—S— and/or Co—Ni—W—S-Sites for Hydrogen Formation

Nan Topsøe and Henrik Topsøe were the first to identify the active Co—Mo—S—, Ni—Mo—S— and Co—Ni—Mo—S-sites on sulfided catalysts for hydrodesulfurization (HDS) and hydrodenitrogenation (HDN) [A, B]. Over the years the Topsøe group has shown that the density of these active Co—Mo—S—, Ni—Mo—S— and Co—Ni—Mo—S-sites can be quantified by NO or CO adsorption, and furthermore, that the concentration of these edge sites on sulfided Co/Ni—MoS₂ catalysts can be correlated with the overall catalytic activity [C]. The catalysts are often made by pore filling of γ-Al₂O₃ or a suitable zeolite system with Mo, W, Ni and/or Co, in one or more steps, followed by calcination forming γ-Al₂O₃ or zeolite supported mixed oxide systems. The mixed oxides are subsequently sulfided in e.g. H₂S to obtain active HDN/HDS catalysts.

The uniqueness of the Co—Mo—S—, Ni—Mo—S—, Co—Ni—Mo—S, Co—W—S—, Ni—W—S—, Co—Ni—W—S-sites formed at the edges of MoS₂/W_{S}2 clusters has been further supported by Density-functional theory (DFT) calculations [D, E]. Topsøe et al. has suggested that these sites are promoting good hydrogenation properties with unique hydrogen interaction.

Hence, the present patent application suggests to synthesis Co—Mo—S—, Ni—Mo—S—, Co—Ni—Mo—S, Co—W—S—, Ni—W—S— and/or Co—Ni—W—S-sites on nickel foam substrate by the suggested step1/step2 procedure or combination of several step1's/step2's forming active electrodes for alkaline electrolysis.

Especially as the unique activity is associated with sulfur deficient sites approaching a metallic nature which is expected to be highly active/beneficial for the formation of hydrogen at a lower voltage in alkaline environments [E, F].

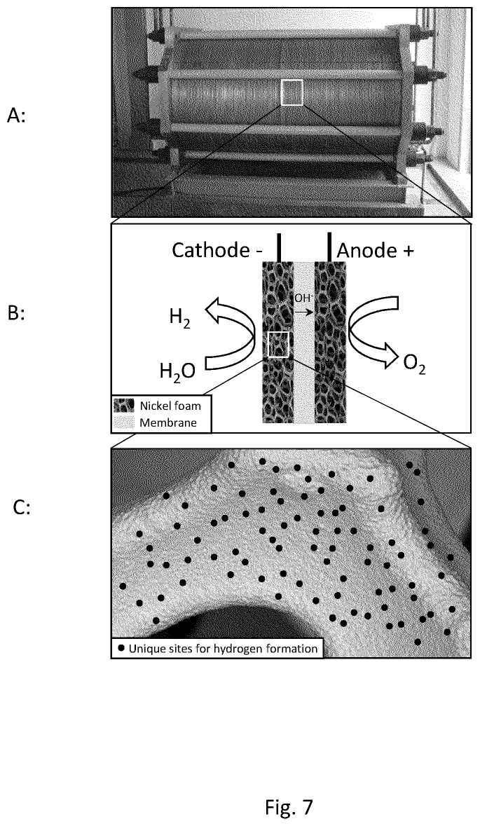

FIG. 7 C) shows a schematic illustration of these proposed unique electrocatalytic sites on a section of Ni foam according to the invention for hydrogen formation in the lower third section. The suggested electrodes may also be used on the anode side. In the middle B) section, the Ni foam on both the anode and the cathode side is schematically illustrated with a membrane where OH− can be transported. In section A), a photograph of an electrolysis configuration is shown based on Ni foam electrodes.

### Example 5: Direct Heating of Ni Foam in H₂S

In one embodiment of the present invention, a nickel foam may be heated in a H₂S containing atmosphere converting the Ni-substrate (+surface oxidized substrate (NiO)) into a Ni—S phase. Depending on how extensive the sulfiding process should be, it may be necessary to heat to higher temperatures. It could be enough to heat to between 200-600° C. However, some experiments suggest that maximum temperatures of about 75, 90, 100, 150, 200 degrees C. may be sufficient for performing the sulfiding process step S2, which is favorable for practical implementation, saves energy, and minimizes the possible negative impact of heating the electrode unnecessary. Time is of course also a relevant factor as the skilled person in surface chemistry will readily understand, such process time of sulfiding may be 5, 10, 15, 20, 30, or 40 hours of maximum treatment time, though it naturally also depends on the flow of H₂S and the concentration. Also, lower temperatures are beneficial preserving the mechanical and stable properties of the Ni foam.

### Example 6: Coating of Nickel Foam with e.g. Mo Followed by Heating in H₂S

In one embodiment of the invention, a nickel foam may be electroplated by e.g. Mo (or other metals) followed be heated in a H₂S containing atmosphere converting part of the Ni-substrate (+surface oxidized substrate (NiO)) and the plated Mo into a Mo—S/NiMOS phase. Depending on how extensive the sulfiding process should be, it will be necessary to heat to higher temperatures. It could be enough to heat to between 200-600° C. However, some experiments suggest that maximum temperatures of about 75, 90, 100, 150, 200 degrees C. may be sufficient for performing the sulfiding process step S2 as mentioned above. Also, lower temperatures are beneficial preserving the mechanical and stable properties of the Ni foam.

### Example 7: Example 6 Followed by Ni and/or Co Coating and Heating in H₂S

Examples 6 might also be followed by electroplating with Ni and/or Co after Mo coating or after Mo coating and heating in H₂S to create CoMOS and NiMOS sites. Depending on how extensive the sulfiding process should be, it will be necessary to heat to higher temperatures. It could be enough to heat to between 200-600° C. However, some experiments suggest that maximum temperatures of about 75, 90, 100, 150, 200 degrees C. may be sufficient for performing the sulfiding process step S2 as mentioned above. Also, lower temperatures are beneficial preserving the mechanical and stable properties of the Ni foam.

### Example 8: Example 5-7 Involving Pre- and/or Post-Treatments

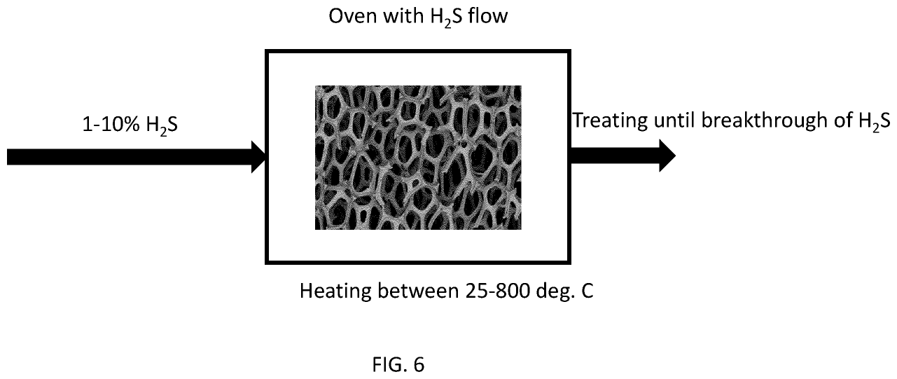

Example 5-7 might be combined with any pre- and/or post-treatments involve e.g. heating in air converting metal to metal oxides before sulfiding in H₂S. Depending on the degree of oxidation, it will be necessary to heat to higher temperatures. It could be enough to heat to between 200-600° C. However, some experiments suggest that maximum temperatures of about 75, 90, 100, 150, 200 degrees C. may be sufficient for performing the sulfiding process step S2 as mentioned above. Also, lower temperatures are beneficial preserving the mechanical and stable properties of the Ni foam. For example, FIG. 4 shows pre-treatment S_Pre with heating following by S1 (for example metal electroplating) and S2 (for example sulfiding by H₂S treatment shown in FIG. 6), where post-treatment S_Post with heating is followed by a first repeating of S1 and S2, the repeating being name S3.

In FIG. 6, a sulfiding is performed in a heated oven, where a flow of H₂S containing gas in various concentration, such as 1-10%, is flowing through the Ni foam substrate. The sulfiding may be considered completed from a practical point of view when the gas is flowing through the Ni foam as schematically indicated to the right in FIG. 6 end there is no longer any H₂S consumption.

### Example 9: Example 5-8 Including Additional Steps of the Step1 and/or Step2 Types

In another embodiment of the proposed production of electrodes one might combine example 5-9 with any other number of Step 1 (S1) and/or Step 2 (S2) including one or more post-/pre-treatments/intermediate treatments and permutations hereof, as for example shown in FIG. 4.

### Example 10: Example 5-9 Including Other Metals

Other metals such as Cr, Fe, and/or Cu could be applied, and instead of sulfiding step2 could involve Se or Te as explained above.

### Example 11: Sulfiding of Ni Foam—SEM Images and Polarization Curves

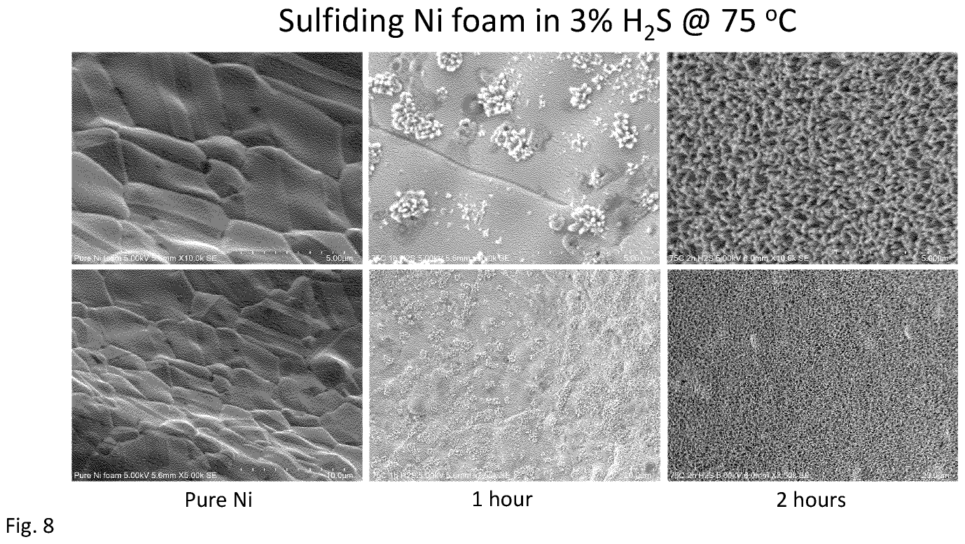

FIG. 8 shows the effect of sulfiding a Ni foam in 3% H₂S at 75 deg. C., where the two left SEM images (high and low magnification) shows the pure Ni surface before sulfiding, whereas the middle and right SEM images show the effect of 1 hours and 2 hours sulfiding, respectfully. The sulfiding effect is clearly seen on the surface and the interpretation is that the sulfiding is creating new surface morphology, higher surface area and a new types of active nano sites.

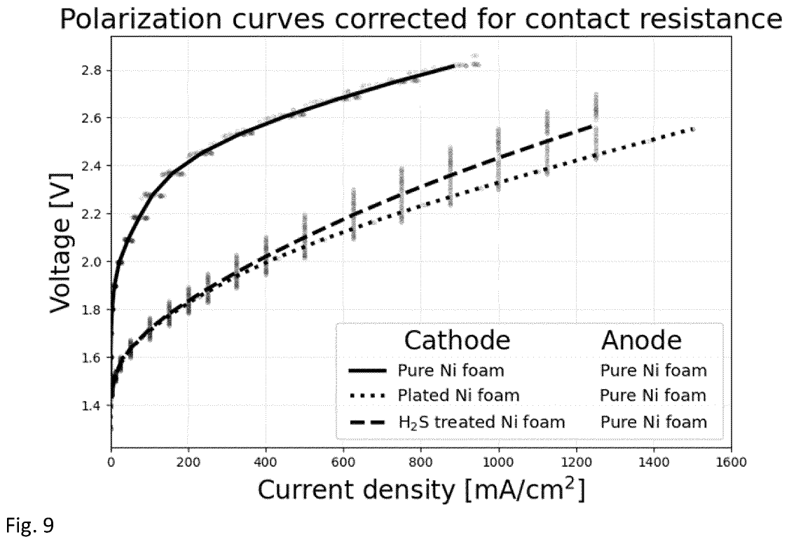

FIG. 9 shows three polarisation curves for the necessary voltage for hydrogen/oxygen formation as a function of the applied current density in 30% KOH at 90 deg. C. for various treatment of Ni foam. The upper, solid curve is for Ni foam at the cathode (C) and Ni foam at the anode (A). The lower, dotted curve is the needed voltage for hydrogen formation at the cathode (C) (ex situ sulfided in a furnace) and pure Ni foam at the anode (A). Clearly, a significantly lower voltage is needed for hydrogen formation. The middle, hashed curve shows the performance of a H₂S treated (ex situ in a furnace) Ni foam at the cathode (C) and pure Ni foam at the anode (A). This clearly show that sulfiding has an impact on both the anode (oxygen formation) and cathode (hydrogen formation). Measured data are shown as points whereas the three fitted curves are based on average values.

### REFERENCES

[A] N. Y. Topsøe & H. Topsøe, Adsorption studies on hydrodesulfurization catalysts. Infrared and volumetric study of NO adsorption on alumina-supported Co, Mo, and Co—Mo catalysts in their calcined state. Journal of Catalysis 75(1982), 354-374.
[B] N. Y. Topsøe & H. Topsøe, Characterization of the structures and active-sites in sulfided Co—Mo/Al₂O₃ and Ni—Mo/Al₂O₃ catalysts by No chemisorption. Journal of Catalysis 84(1983)386-401.
[C] H. Topsøe, B. S. Clausen & F. E. Massoth, Hydrotreating Catalysis Vol. 11 (Springer Verlag, 1996).
[D] Poul Georg Moses, Berit Hinnemann, Henrik Topsøe, Jens K. Nørskov, Spectroscopy, microscopy and theoretical study of NO adsorption on MoS₂, Journal of Catalysis Volume 268(2009)201-208.
[E] H. Topsøe, The role of Co—Mo—S type structures in hydrotreating catalysts, Applied Catalysis A: Volume 322(2007), 3-8.
[F] Nan-Yu Topsøe, Anders Tuxen, Berit Hinnemann, Jeppe V. Lauritsen, Kim G. Knudsen, Flemming Besenbacher, Henrik Topsøe, Spectroscopy, microscopy and theoretical study of NO adsorption on MoS₂ and Co—Mo—S hydrotreating catalysts, Journal of Catalysis, 279(2011)337-351.

In short, the present invention relates to a method for producing an electrode for alkaline electrolysis based on a composition of metal sulfides on a Ni foam substrate. The metal can be Mo, Ni, Co, Fe and/or W. In a first step S1), there is performed a metal deposition, e.g. by electroplating, the metal, Me1/Me2, being Mo, Ni, Co, Fe, and/or W, on a Ni foam substrate resulting in a metal-Ni compound being formed on and/or in the Ni foam substrate. In a second step, S2) there is performed a sulfiding on the metal-Ni compound from the first step S1). The third step S3) is an optional repetition of S1 and/or S2 at least one time. The step S1) and step S2) thereby results in the formation of electrocatalytic active nano-sites with Me1-Me2-S—Ni compounds. It is found that these nano-sites are capable of reducing the so-called overpotential of the electrodes during alkaline water electrolysis, and the production of electrodes may be significantly simplified.

1. A method for producing an electrode for alkaline electrolysis based on a composition of metal sulfides on a Ni foam substrate, the metal being Mo, Ni, Co, Fe and/or W, the method comprising initially providing a nickel (Ni) foam substrate, the method comprising the separate steps of:
S1) performing a metal deposition, preferably by electroplating, the metal being Mo, Ni, Co, Fe, and/or W, on said Ni foam substrate resulting in a metal-Ni compound being formed on and/or in the Ni foam substrate, and
S2) performing a sulfiding on said metal-Ni compound, and
S3) optionally repeating, at least one time, said step S1) and/or said step S2),
thereby resulting in the formation of electrocatalytic active nano-sites comprising Me1-Me2-S—Ni compounds capable of reducing the overpotential of the electrode during alkaline water electrolysis, wherein Me1 is a metal chosen from the group consisting of Mo, Ni, Co, Fe, and/or W, and wherein Me2 is a metal chosen from the group consisting of Mo, Ni, Co, Fe, and/or W.

2. The method for producing an electrode according to claim 1, wherein step S1) and step S2) are performed as separate and distinct steps in a production line for manufacturing the electrode.

3. The method for producing an electrode according to claim 1, wherein the Me1 metal is different from the Me2 metal.

4. The method for producing an electrode according to claim 3, where said Me1 metal and said Me2 metal are being deposited in separate and distinct steps S1) of metal deposition.

5. The method for producing an electrode according to claim 3, wherein said Me1 metal and said Me2 metal depositions are performed in separate and distinct places in a production line for manufacturing the electrode.

6. The method for producing an electrode according to claim 1, wherein the Me1 metal is different from the Me2 metal, and where said Me1 metal and said Me2 metal are being deposited in the same step S1) of metal deposition.

7. The method for producing an electrode according to claim 1, where the metal deposition step S1) is performed by electroplating, preferably DC electroplating, pulse electroplating or ionic electroplating, or any combinations thereof.

8. The method for producing an electrode according to claim 1, where the step S2) of sulfiding on said metal-Ni compound is performed with a sulfiding medium comprising hydrogen sulfide, H₂S, alternatively dimethyl sulfide (DMS), dimethyl sulfoxide (DMSO, (CH₃)₂SO), Ethyl Mercaptan (CH₃CH₂SH), Butyl Mercaptan (C₄H₁₀S), thiourea, C₂S₂ or H₂S₂.

9. The method for producing an electrode according to claim 1, wherein the Ni foam is replaced by a foam from any of the metals chosen from the group consisting of Fe, Co, Cr, and Cu.

10. The method for producing an electrode according to claim 1, wherein an additional heating step is performed:
S_Pre) before step S1) metal deposition,
S_Inter) between S1) metal deposition and S2) sulfiding, and/or
S_Post) after S2) sulfiding, and any combinations thereof.

11. The method for producing an electrode according to claim 1, wherein the electrocatalytic active nano-sites comprising Me1-Me2-S—Ni compounds capable of reducing the overpotential of the electrode during alkaline water electrolysis comprises primarily edge sites situated on the edge of the said nano-sites.

12. The method for producing an electrode according to claim 1, wherein the electrocatalytic active nano-sites comprising Me1-Me2-S—Ni compounds capable of reducing the overpotential of the electrode during alkaline water electrolysis comprises primarily sulfur deficient sites with near metallic properties.

13. The method for producing an electrode according to claim 1, wherein the electrocatalytic active nano-sites comprising Me1-Me2-S—Ni compounds are capable of reducing the overpotential of the electrode during alkaline water electrolysis at least 0.2 V, preferably at least 0.3 V, more preferably at least 0.4 V.

14. The method for producing an electrode according to claim 1, wherein the Ni foam is replaced by a Ni woven structure, a Ni plate, or a Ni mesh.

15. The method for producing an electrode according to claim 1, wherein the step S2) of sulfiding of said Ni foam substrate is performed with a gas, preferably with a H₂S gas, optionally with a composition of 1-10 vol. % H₂S, preferably 2-4 vol. % H₂S, more preferably around 3 vol. % H₂S.

16. The method for producing an electrode according to claim 1, wherein the step S2) of sulfiding of said Ni foam substrate is performed only on a surface part of the Ni foam substrate.

17. An electrode manufactured according the method of claim 1.

18. An electrolysis system comprising one or more electrodes manufactured according to claim 1.
